(19) United States
(12) Patent Application Publication
(10) Pub. No.: US 2006/0208485 A1
(43) Pub. Date: Sep. 21, 2006

(54) Connection element for the transport of gaseous, liquid or solid materials

(75) Inventors: Thomas Discher, Felsberg (DE); Uwe Martin, Bad Hersfeld (DE); Ruediger Stange, Nentershausen (DE); Thomas Werner, Nentershausen (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 11/352,219

(22) Filed: Feb. 13, 2006

(30) Foreign Application Priority Data
Mar. 8, 2005 (DE) 10 2005 010 664.1

(51) Int. Cl. F16L 39/00

(52) U.S. Cl. 285/319; 285/903; 285/921

(57) ABSTRACT

The connection element includes a tubular coupling which is connected on the inside at one end to a hose which has, on its side facing away from the hose , at least one clearance, of which the lateral edges running parallel to the longitudinal axis of the tubular coupling run, in the cross section of the respective clearance, so as to widen conically with respect to one another from the inside outward. The tubular coupling has at the other end, on the outside, at least one first projection which bears against one end face of a snap ring which is arranged between the at least one projection and the one end of the coupling, around the coupling on the outside.

### BACKGROUND OF THE INVENTION

The invention relates to a connection element for the transport of gaseous, liquid or solid materials and to the use of the connection element.

Connection elements for the transport of gaseous, liquid or solid materials are known. DE 103 22 972 A1 describes a corresponding connection element consisting of a tubular coupling which has on the inside a first clearance running cylindrically, in which a corrugated hose is arranged and which has a cylindrically running second clearance which is contiguous to the first clearance and in which an annular seal with respect to the first clearance is arranged and a spreading ring is arranged adjacently to the annular seal, the spreading ring having on the outside a first projection which points toward the coupling and which engages into a continuous groove arranged in the second clearance, and in which the spreading ring is in engagement with a projection pointing toward the corrugated hose and the annular seal is in engagement with the corrugated hose, in each case from outside. The known connection elements for the transport of gaseous, liquid or solid materials have the disadvantage, as a rule, that relatively high insertion forces act on the connection elements, thus making it difficult to release the connection elements. In order to counteract this disadvantage, it is known to use correspondingly softer, more elastic materials. The use of these, however, has the disadvantage that the individual connections may, in structural terms, automatically come loose too quickly, and this is likewise undesirable.

### SUMMARY OF THE INVENTION

The object on which the invention is based is therefore, to provide a connection element for the transport of gaseous, liquid or solid materials, in which the insertion forces can be kept relatively low, while at the same time an automatic release can be avoided. The object on which the invention is based is, furthermore, to provide a use for the connection element.

The object on which the invention is based is achieved by means of a connection element for the transport of gaseous, liquid or solid materials, consisting of a tubular coupling which is connected on the inside at one end to a hose which has, on its side facing the hose at least one clearance, of which the lateral edges running parallel to the longitudinal axis of the tubular coupling run, in the cross section of the respective clearance, so as to widen conically with respect to one another from the inside outward, which has at the other end, on the outside, at least one first projection which bears against one end face of a snap ring which is arranged between the at least one projection and the one end of the coupling, around the coupling on the outside, and has at least one tab which is formed by a U-shaped clearance and which, on its free end face facing away from the one end of the coupling, has a second projection which is directed toward the longitudinal axis of the coupling and which engages into the at least one clearance, and in which the coupling has on the inside a stop for a first seal introduced in the direction of the hose. The connection between the tubular coupling and the hose may take place in various ways. The hose used may be, for example, a corrugated hose. The term “U-shaped clearance” is to be understood as meaning a clearance which has a U-shape in a top view of the casing side of the snap ring. The U-shape also in this case includes, for example, profiles of the clearance in the form of a parabola. As a rule, the seal used is advantageously a sealing ring. It is of great importance particularly when liquid materials are to be transported. The tubular coupling and the snap ring consist of elastic materials. They may consist, for example, of polyoxymethylen (POM). It was shown, surprisingly, that the connection element has only relatively low insertion forces. The snap ring can therefore be released from the tubular coupling by means of a slight rotation, this becoming possible owing to the special design of the lateral edges of the at least one clearance which, of course, run obliquely outward. In the connected state, however, the snap ring and the tubular coupling cannot be released from one another in the direction of the longitudinal axis, and therefore the connection element at the same time ensures a reliable connection.

In a preferred embodiment of the invention, the first seal is arranged between the first step and a cross-sectional narrowing. The cross-sectional narrowing may in this case, for example, be of bead-like design. This advantageously makes mounting easier during the assembly of the connection element, since the first seal can be fixed in the tubular coupling relatively simply.

In a further preferred embodiment of the invention, there is provision for the first outside diameter D1 of the coupling in the region between the at least one clearance and the one end to amount to 1.1 to 1.15 times the second outside diameter D2 of the coupling in the region between the at least one clearance and the other end. The advantageous reduction in the second outside diameter D2, as compared with the first outside diameter D1, makes it easier for the snap ring to be pushed onto the tubular coupling, since the snap ring, when being pushed on in this way, has to be pushed over the first projection of the tubular coupling, and in this case, at this point, there is a slight upsetting of the tubular coupling which is assisted by the slight reduction in material. The connection element can thus be premounted more easily.

According to a further embodiment of the invention, that end face of the second projection which faces away from the hose is beveled outward at an angle of inclination a in the range of 9° to 11°. The second projection of the at least one tab of the snap ring serves for fixing a junction piece having a mushroom head which is pushed into the connection element for the use of the latter. If, then, tensile forces arising from the connection element act on this junction piece, the result of this is that the second projection of each tab is pressed outward. However, as a result of the beveled end face, there is an advantageous undercut which counteracts this force action.

Finally, the subject of the invention is also the use of the connection element as a subassembly in windshield washing systems. The use of the connection element in windshield washing systems of motor vehicles is particularly advantageous in this context. In windshield washing systems, as a rule, a plurality of connection elements are arranged, the connection of which is, however, at the same time to be easily releasable again in a reliable way. Owing to the structural embodiment, the connection element is therefore especially suitable as a subassembly in windshield washing systems.

### BRIEF DESCRIPTION OF THE SEVERAL VIEWS OF THE DRAWINGS

The invention is explained below in more detail, and by way of example, with reference to the drawings (FIG. 1a), b); FIG. 2a), b); FIG. 3a) , b), c); FIG. 4).

FIGS. 1a), b) show the connection element in longitudinal section and three-dimensionally in the form of an exploded drawing.

FIGS. 2a), b) show the connection element in longitudinal section and three-dimensionally in the assembled state.

FIGS. 3a), b), c) show the connection of the connection element to a junction piece having a mushroom head, in each case in steps in longitudinal section.

FIG. 4 shows a detail X according to FIG. 3c) in an enlarged illustration.

### DETAILED DESCRIPTION OF THE INVENTION

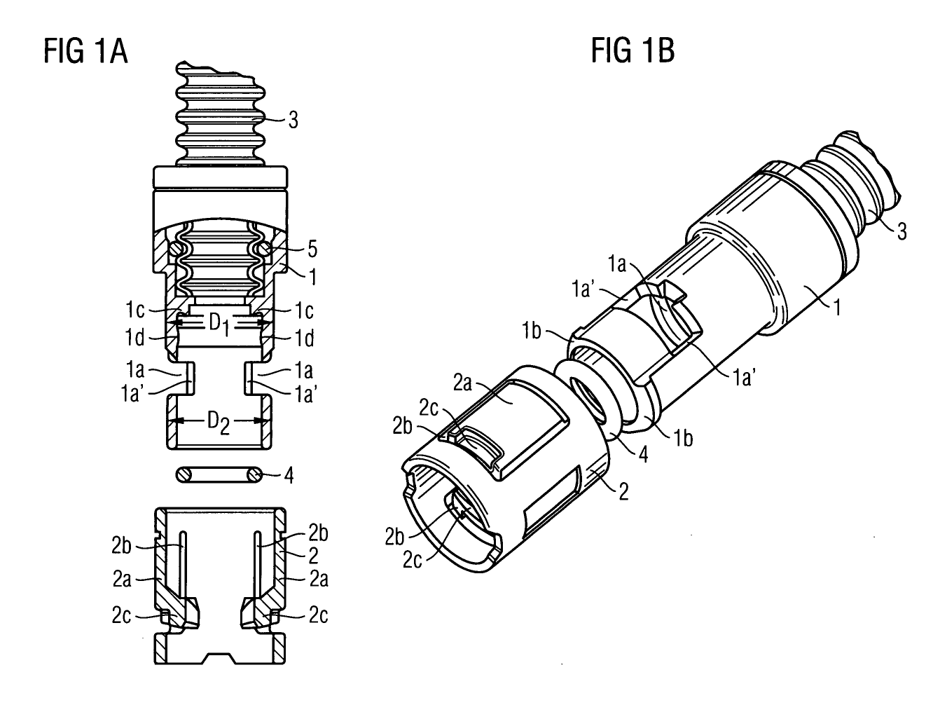

FIGS. 1a), b) illustrate the connection element for the transport of gaseous, liquid or solid materials respectively in longitudinal section and three-dimensionally in the form of an exploded drawing. The connection element consists of a tubular coupling 1 which is connected on the inside at one end to a hose 3 which, in the present case, is designed as a corrugated hose. Sealing off in this case takes place by means of the arrangement of a second seal 5. The tubular clutch 1 has, on its side facing away from the hose 3, two clearances 1a, of which the lateral edges. 1a′ running parallel to the longitudinal axis of the tubular coupling 1 run, in the cross section of the respective clearance 1a, so as to widen conically with respect to one another from the inside outward. Two first projections 1b are arranged on the outside at the other end of the tubular coupling 1 and, in the assembled state (not illustrated), bear against one end face of a snap ring 2 which is then arranged between the at least one projection 1b and the one end of the coupling 1, around the coupling 1 on the outside. The snap ring 2 has two tabs 2a which are formed in each case by a U-shaped clearance 2b and which, on their free end faces facing away from the one end of the coupling 1, have in each case a second projection 2c which is directed toward the longitudinal axis of the coupling 1 and, in the assembled state, engages into the at least one clearance 1a. Furthermore, the coupling 1 has a stop 1c for a first seal 4 introduced in the direction of the hose 3. In order to position the first seal 4 in the tubular coupling 1 in an especially advantageous way, a cross-sectional narrowing 1d is arranged, between which and the first stop 1c the first seal 4 is positioned in the assembled state. The first outside diameter D1 of the coupling 1 in the region between the at least one clearance 1a and the one end amounts to 1.1 to 1.15 times the second outside diameter D2 of the coupling 1 in the region between the at least one clearance 1a and the other end. This makes it easier for the snap ring 2 to be pushed onto the tubular coupling 1 over the two projections 1b.

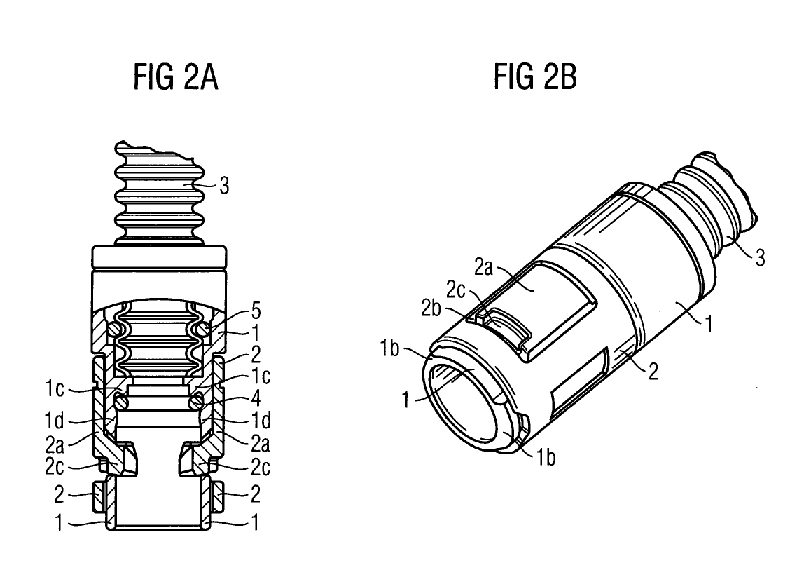

FIGS. 2a), b) illustrate the connection element in the assembled state in longitudinal section and three-dimensionally. In this state, the connection element is ready for the reception of a junction piece having a mushroom head (not illustrated). The snap ring 2 is arranged positively on the tubular coupling 1 and is secured against release in the longitudinal direction by the first two projections 1b and as a result of the engagement of the second projection 2c.

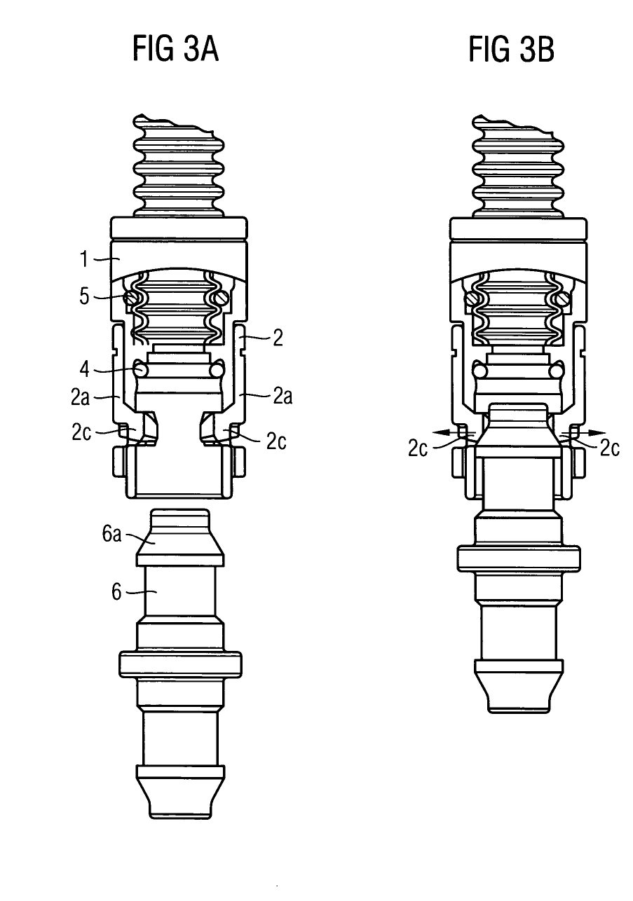

FIG. 3a illustrates the operation of connecting the connection element to a junction piece 6 having a mushroom head 6a in steps in longitudinal direction. The junction piece 6 is in this case introduced into the connection element in the longitudinal direction. The junction piece 6 in this case butts with the outer region of the mushroom head 6a against the two second projections 2c and, according to FIG. 3b, presses them outward in the direction of the arrows. During the further introduction of the junction piece 6, the two second projections 2c fold down behind the region of the mushroom head 6a and thus fix the junction piece 6 which then presses with its mushroom head 6a against the first seal 4. In order to release the junction piece 6 again, only a slight rotation of the snap ring 2 is required, and this can take place with relatively little effort due to the special configuration of the lateral edges of the two clearances (not illustrated) of the tubular coupling 1. The junction piece 6 is then released, together with the snap ring 2, from the tubular coupling 1. High insertion forces in this case do not need to be overcome. When tensile forces act on the junction piece 6 in the longitudinal direction in the connected state, as is illustrated in FIG. 3c) by a central arrow, the mushroom head 6a presses with its rear side against the two second projections 2c, so that these are pressed outward in the lateral direction of the arrow according to FIG. 3c). In order to counteract this adverse force action, the end face of each second projection 2c is beveled outward according to the detail X.

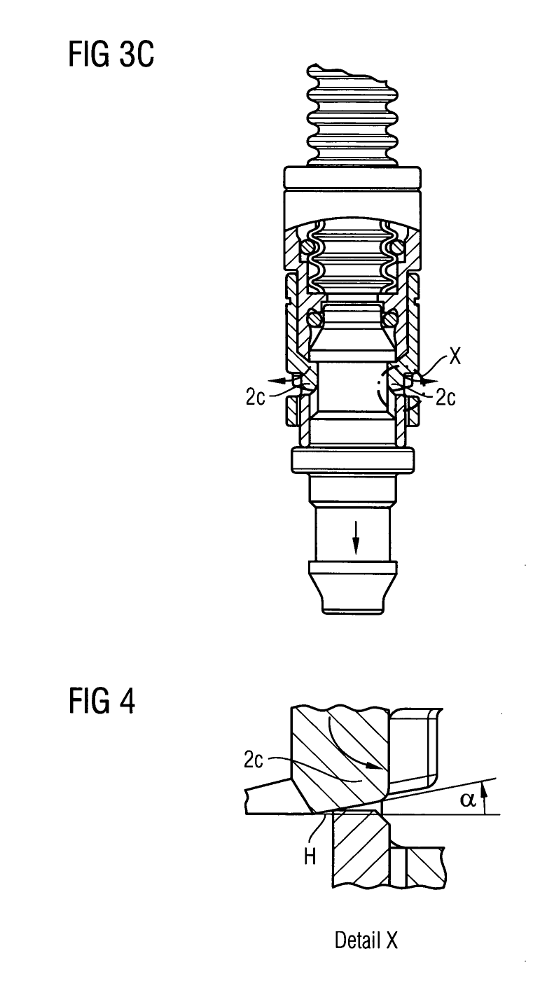

FIG. 4 illustrates, enlarged, the detail X according to FIG. 3c). The adverse force action runs in the direction of the arrow. As a result of the beveled run of the end face of the second projection 2c at an angle of inclination α in the range of 9° to 11°, an undercut H, as it is known, is produced, which prevents or counteracts a breakaway of the respective second projection 2c. The connection in the connection element is thereby reinforced in an especially advantageous way.

1. A connection element for the transport of gaseous, liquid or solid materials, comprising a tubular coupling which is connected on the inside at one end to a hose which has, on its side facing away from the hose, at least one clearance, of which the lateral edges running parallel to the longitudinal axis of the tubular coupling run, in the cross section of the respective clearance, so as to widen conically with respect to one another from the inside outward, which has at the other end, on the outside, at least one first projection which bears against one end face of a snap ring which is arranged between the at least one projection and the one end of the coupling, around the coupling on the outside, and has at least one tab which is formed by a U-shaped clearance and which, on its free end face facing away from the one end of the coupling, has a second projection which is directed toward the longitudinal axis of the coupling and which engages into the at least one clearance, and in which the coupling has on the inside a stop for a first seal introduced in the direction of the hose.

2. The connection element according to claim 1, wherein the first seal is arranged between the first stop and a cross-sectional narrowing.

3. The connection element according to claim 1, wherein the first outside diameter D1 of the coupling in the region between the at least one clearance and the one end amounts to 1.1 to 1.15 times the second outside diameter D2 for the coupling in the region between the at least one clearance and the other end.

4. The connection element according to claim 1, wherein an end face of the second projection which faces away from the hose is beveled outward at an angle of inclination α in the range of 9° to 11°.
